(19) United States
(12) Patent Application Publication
(10) Pub. No.: US 2014/0195339 A1
(43) Pub. Date: Jul. 10, 2014

(54) Media Mix Modeling Tool

(71) Applicant: ADOBE SYSTEMS INCORPORATED, San Jose, CA (US)

(72) Inventors: Trevor H. Paulsen, Lehi, UT (US); Jessica L. Langford, Provo, UT (US); Jared A. Lees, Orem, UT (US)

(73) Assignee: Adobe Systems Incorporated, San Jose, CA (US)

(21) Appl. No.: 13/736,710

(22) Filed: Jan. 8, 2013

(51) Int. Cl. G06Q 30/02

(52) U.S. Cl. CPC G06Q 30/0247
USPC 705/14.46

(57) ABSTRACT

A media mix modeling tool is configured to enable a marketing budget to be analyzed for purposes of allocation across different marketing channels and campaigns. The media mix modeling tool utilizes and builds upon web analytics data. For example, for particular channels that are to be the subject of a marketing investment, web analytics data is gathered for each channel. A statistical attribution method is then utilized to analyze the web analytics data to determine how much revenue should be attributed to each channel based on various touch points for each campaign. Cost data is then utilized to create a plot of campaigns within a particular channel. From this plot, a model is fitted that describes the performance of the particular channel. Once a model has been fit to each individual channel, a solver is applied to find a desirable or optimal way to distribute the marketing budget.

### BACKGROUND

Many companies utilize marketing services to manage their marketing budgets across a variety of marketing channels to ensure efficient usage of their budget. Marketing services can, however, be very expensive and may not necessarily utilize the most useful information and data available.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

Various embodiments provide a media mix modeling tool that is configured to enable a marketing budget to be analyzed for purposes of allocation across different marketing channels and campaigns. In one or more embodiments, the media mix modeling tool utilizes and builds upon web analytics data. For example, for particular channels that are to be the subject of a marketing investment, web analytics data is gathered for each channel. A statistical attribution method is then utilized to analyze the web analytics data to determine how much revenue should be attributed to each channel based on various touch points for each campaign. Cost data is then utilized to create a plot of campaigns within a particular channel. From this plot, a model is fitted that describes the performance of the particular channel. Once a model has been fit to each individual channel, a solver is applied to find a desirable or optimal way to distribute the marketing budget.

In one or more embodiments, a user interface is provided in the form of a dashboard to enable running of the models mentioned above and display of resultant data in an intuitive and user-friendly manner that provides flexibility in so far as enabling users to enter several budgets. The dashboard can enable users to ascertain their theoretical return for each of the budgets that are entered and to determine where their marketing dollars should be allocated.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 illustrates a media mix modeling module in accordance with one or more embodiments.

FIG. 2a illustrates an example user interface that includes a scatter plot in accordance with one or more embodiments.

FIG. 3 illustrates an example system in accordance with one or more embodiments.

FIG. 4 illustrates an example user interface/dashboard in accordance with one or more embodiments.

FIG. 5 illustrates an additional portion of the example user interface/dashboard illustrated in FIG. 4, in accordance with one or more embodiments.

FIG. 6 is a flow diagram depicting a procedure in an example implementation in accordance with one or more embodiments.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

### Overview

Various embodiments provide a media mix modeling tool that is configured to enable a marketing budget to be analyzed for purposes of allocation across different marketing channels and campaigns.

A “marketing channel” refers broadly to various avenues that are utilized by marketers to make products and services available to consumers. In the context of online or Internet marketing, such marketing channels can include, by way of example and not limitation, search engine optimization, pay per click campaigns, social media marketing, affiliate marketing, shopping channel management, mobile marketing, video marketing, e-mail marketing, display advertising, and online PR and article marketing. A “campaign” refers to specific efforts within a channel that are utilized to effectuate marketing. For example, for an e-mail marketing channel, the campaign would refer to a specific e-mail that is prepared and sent to one or more potential customers.

In one or more embodiments, the media mix modeling tool utilizes and builds upon web analytics data. For example, for particular channels that are to be the subject of a marketing investment, web analytics data is gathered for each channel. A statistical attribution method is then utilized to analyze the web analytics data to determine how much revenue should be attributed to each channel based on various touch points for each campaign. Cost data is then utilized to create a plot of campaigns within a particular channel. From this plot, a model is fitted that describes the performance of the particular channel. Once a model has been fit to each individual channel, a solver is applied to find a desirable or optimal way to distribute the marketing budget.

In one or more embodiments, a user interface is provided in the form of a dashboard to enable running of the models mentioned above and display of resultant data in an intuitive and user-friendly manner that provides flexibility in so far as enabling users to enter several budgets. The dashboard can enable users to ascertain their theoretical return for each of the budgets that are entered and to determine where their marketing dollars should be allocated.

In the following discussion, an example environment is first described that may employ the techniques described herein. Example embodiments and procedures are then described which may be performed in the example environment as well as other environments. Consequently, performance of the example procedures is not limited to the example environment and the example environment is not limited to performance of the example procedures.

### Example Environment

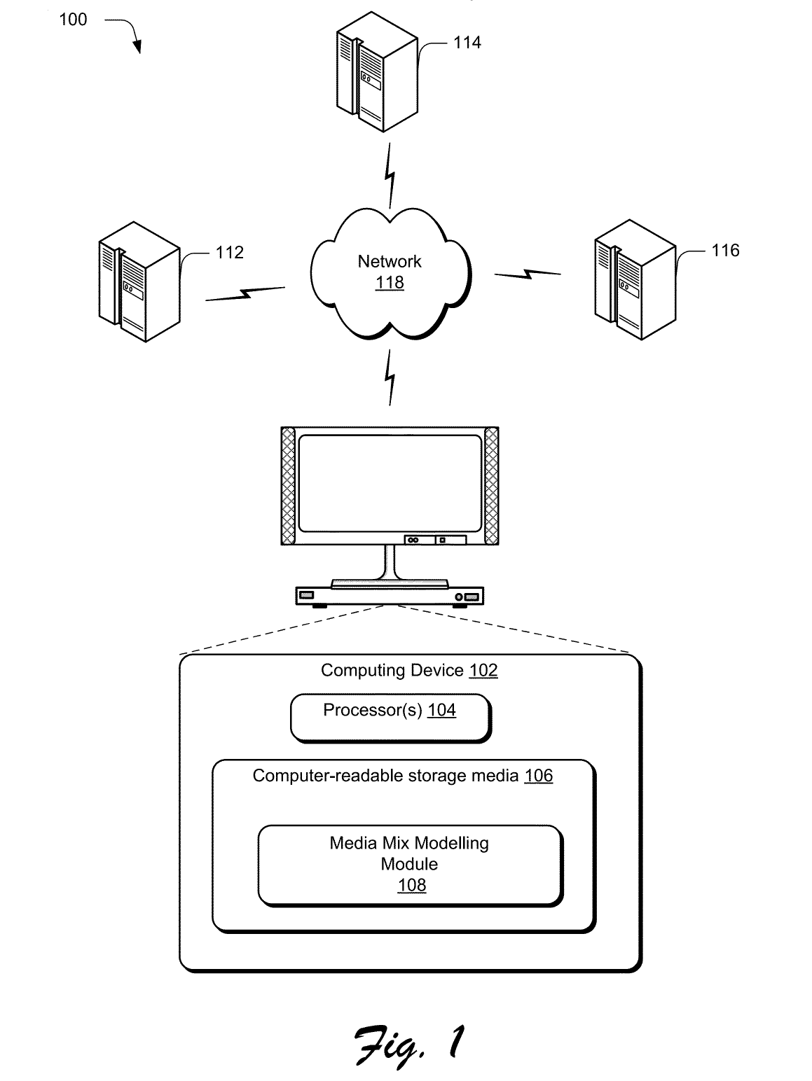

FIG. 1 is an illustration of an environment 100 in an example implementation that is operable to employ techniques described herein. The illustrated environment 100 includes a computing device 102 including one or more processors 104, one or more computer-readable storage media 106 and a media mix modeling module 108 embodied on the computer-readable storage media 106 that operates as described above and below.

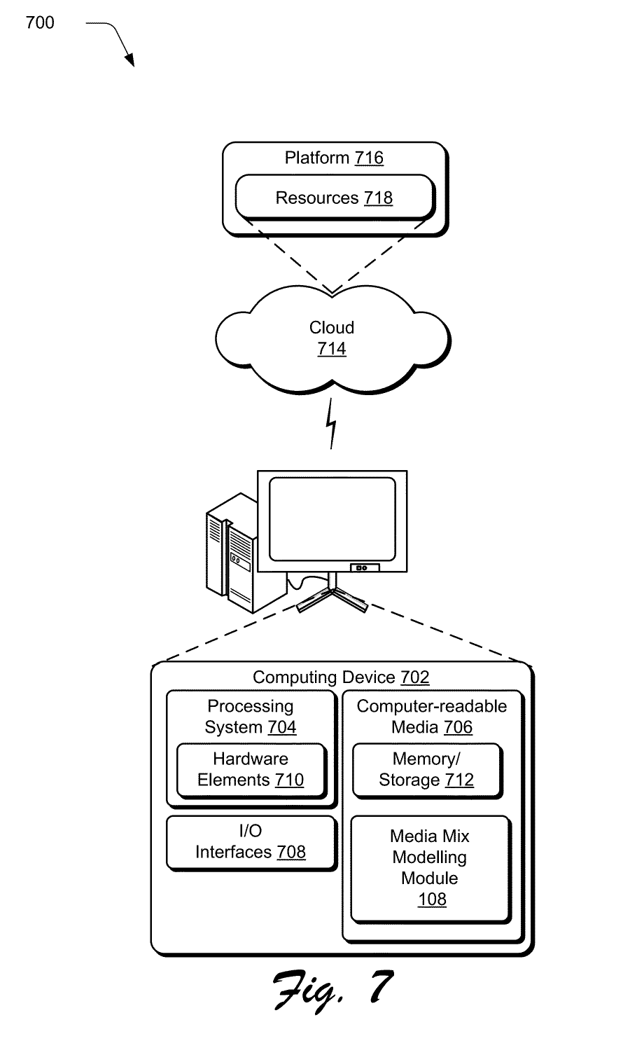

The computing device 102 can be configured as any suitable type of computing device. For example, the computing device may be configured as a desktop computer, a laptop computer, a mobile device (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 7.

The environment 100 also includes one or more servers 112, 114, and 116 configured to communicate with computing device 102 over a network 118, such as the Internet, to provide a “cloud-based” computing environment. The servers 112, 114, and 116 can provide a variety of functionality including, by way of example and not limitation, serving as a repository for web analytics data that can be utilized by the media mix modeling module 108 as described in more detail below.

The servers can also provide various Web-based services such as social networking services, marketing services and the like.

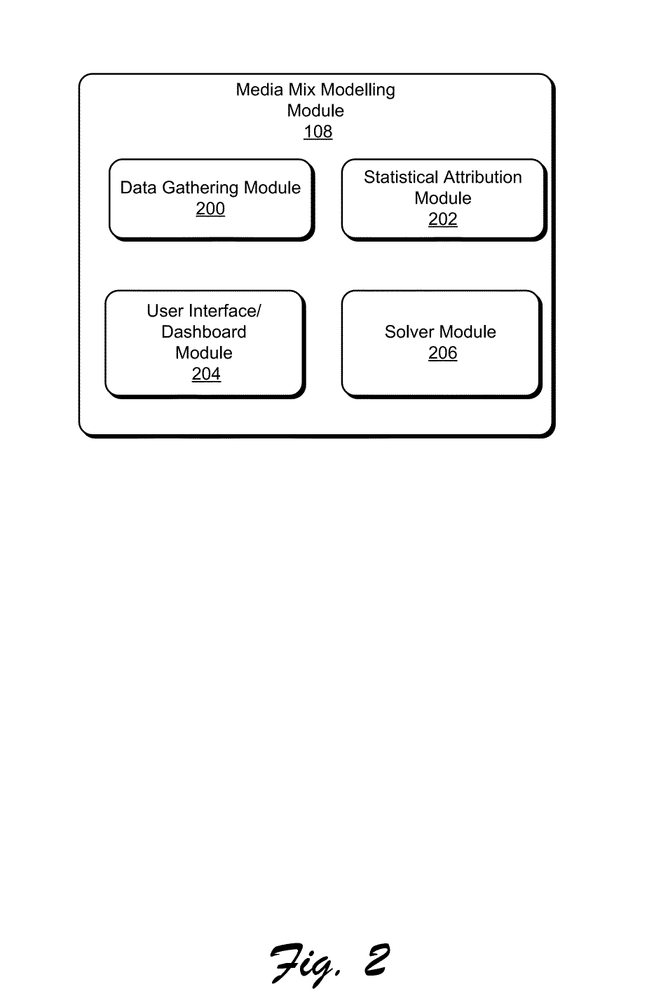

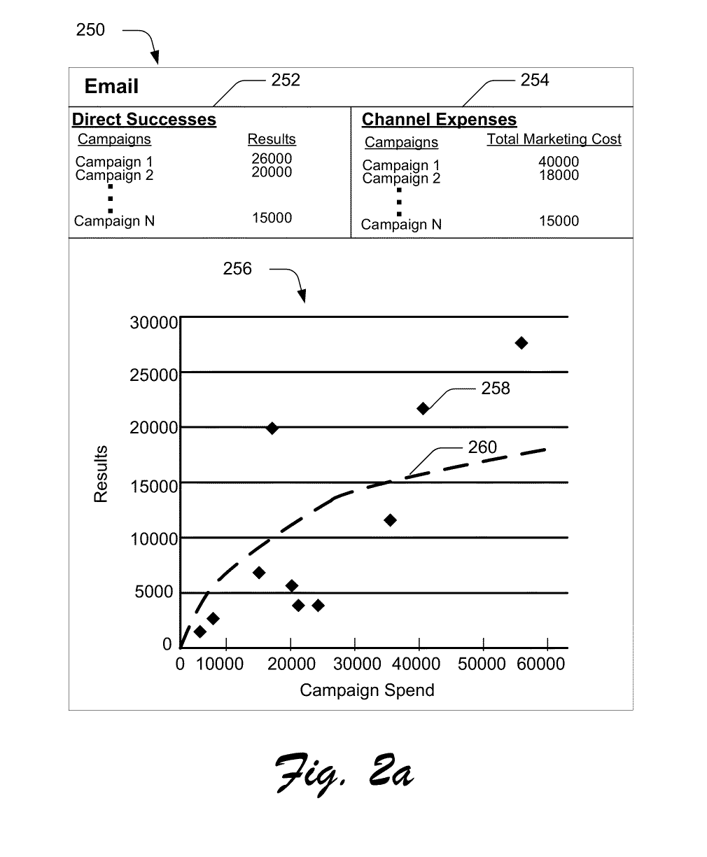

FIG. 2 illustrates media mix modeling module 108 in more detail, in accordance with one or more embodiments. In the illustrated and described example, media mix modeling module 108 includes a data gathering module 200, a statistical attribution module 202, a user interface/dashboard module 204, and a solver module 206.

In one or more embodiments, data gathering module 200 is configured to gather the web analytics data from a suitable repository. The web analytics data can include any suitable type of web analytics data, examples of which are provided below. In one or more embodiments, the web analytics data includes information across a variety of channels and different campaigns within individual channels. For example, the web analytics data can include information about how much money was made as a result of a particular campaign, as well as other information that will be described below.

In one or more embodiments, statistical attribution module 202 is configured to utilize the web analytics data gathered by data gathering module 200 to determine how much revenue should be attributed to each channel based on various touch points for each campaign. A “touch point” refers to a user interaction with a campaign. Examples of touch points include a user clicking clicked through on a campaign, or being presented with some type of ad impression. Touch points can be measured to understand the total “reach” of a campaign.

Any suitable type of statistical attribution model can be utilized. In one or more embodiments, the statistical attribution model utilizes a Bayesian Estimator to attribute revenue to a particular campaign within a channel. A Bayesian Estimator relies on “Bayes Rule” to estimate the probability that a person will convert given that they have “touched” a particular marketing campaign. In operation, the number of campaign touch points and successes are counted. Then, Bayes formula is used to calculate the probability mentioned above. Accordingly, the statistical attribution module 202 provides a mapping of how much money was made from any given campaign and from any given channel.

In one or more embodiments, user interface/dashboard module 204 is configured to enable cost data associated with each channel and campaign within a particular channel to be imported. The user interface/dashboard module 204 analyzes the cost data and the attributed revenue from the statistical attribution module 202 to create a scatter plot of campaigns within a particular channel. This is done for each channel and campaign within a channel. The scatter plot provides a graph of how much was spent on a particular campaign (the x-axis) and return for that particular campaign (the y-axis). Every campaign within a particular channel is plotted in this manner. Next, the user interface/dashboard module 204 utilizes a curve-fitting methodology to fit a curve to the data plotted in the scatter plot. Any suitable type of curve-fitting methodology can be utilized, examples of which are provided below. The curve essentially models the particular channel as a whole and provides an indication of an expected return for money spent within the channel.

As an example, consider FIG. 2a, which illustrates an example user interface in accordance with one or more embodiments generally at 250. There, data for an e-mail marketing channel is shown and includes a direct successes section 252 and a channel expenses section 254. The direct successes section 252 describes the results achieved for each particular campaign within a channel. The channel expenses section 254 describes the total marketing cost for each particular campaign within the channel. This data is then formulated into a scatter plot which is shown just below at 256. Each campaign is represented by a diamond, such as the diamond shown at 258. A curve modeling the e-mail channel is shown at 260.

In one or more embodiments, the curve-fitting methodology utilizes a curve that has a decaying return in order to estimate the diminishing return of spending additional money over time in a particular channel. This approach is used for each channel and the particular campaigns within each channel. Collectively then, at this point, curves have been generated for, and model each channel. The user interface/dashboard module 204 also provides an intuitive visualization that is representative of its analysis, as indicated in FIG. 2a.

Flexibility is enhanced, in at least some embodiments, by enabling the user to enter and modify several parameters of their budget to find a theoretical return for each of those budgets. An example user interface provided by the user interface/dashboard module 204 that enables entry of these parameters is provided below.

In one or more embodiments, solver module 206 (FIG. 2) is configured to analyze the various curves that have been generated for each channel and to compute a distribution of where the marketing budget should be allocated and in which proportions. In one or more embodiments, the solver module 206 employs one or more optimization algorithms to mathematically operate on the curves of all the channels and to compute, from the curves, what can be considered as an optimal marketing budget distribution across the channels. In one or more embodiments, the solver module employs the Microsoft Excel Solver which utilizes the “Generalized Reduced Gradient” algorithm. Other algorithms can be utilized without departing from the spirit and scope of the claimed subject matter, e.g., the Nelder-Mead method of nonlinear optimization, and the like. Solvers can be used to not only determine the overall best marketing mix, but to also determine which curve parameters best describe a particular marketing channel.

Having discussed an example environment in which various embodiments can be employed, consider now an example system that can be utilized to acquire, manage, and store web analytics data that can be utilized by the media mix modeling module 108.

### Example Web Analytics Data Acquisition

One of the powerful aspects of the described embodiments is the combination of web analytics data with an analysis framework that considers revenue attribution and historical market spending to produce a media mix model at a low cost. The web analytics data can be acquired in any suitable way.

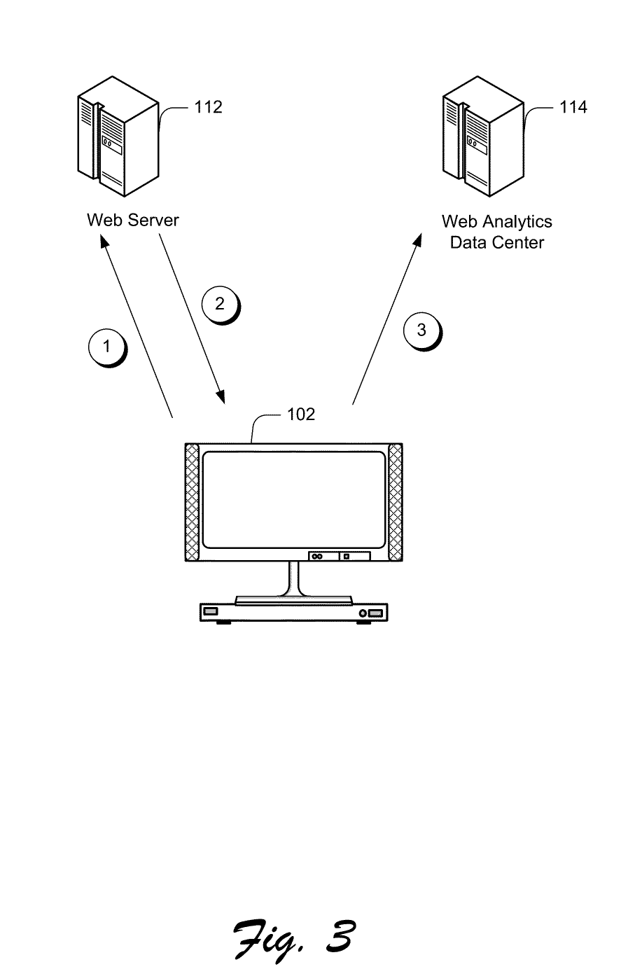

FIG. 3 illustrates but one example system that can be utilized to acquire and maintain web analytics data. The system includes a computing device 102, a Web server 112 that can serve webpages to computing device 102, and a web analytics data center 114.

In operation, the web analytics data center 114 provides an analytics tool that gives marketers actionable, real-time intelligence about online strategies and marketing initiatives. This helps marketers ascertain various activities that take place on their particular website and quickly identify profitable paths through the website. Accordingly, marketers are provided with an ability to understand and measure what is happening on the website and with their online presence so that marketing decisions can be made to maintain and improve their site.

In this particular example, when a user visits a website, represented by the encircled “1”, and receives a webpage from Web server 112, represented by the encircled “2”, the webpage includes code in the form of JavaScript. The JavaScript executes and gathers information pertaining to the user's interaction with the webpage. This information can be specific to the page, specific to the site, and/or specific to the web browser. The JavaScript packages the information that it gathers and sends the information to the web analytics data center 114. The information is then processed by the web analytics data center and placed into tables, reports or other formats that can be used by the owner of the website.

The data that is maintained by the web analytics data center can include, by way of example and not limitation, such things as site metrics including page views, number of visits, time spent per visit, purchases, shopping cart information, and the like. The web analytics data can further include information about a site's content such as which pages were viewed, which site sections were viewed, any video content that might have been consumed, how users are arriving at the website, what campaigns are bringing the users to the website, what products are selling, visitor retention, visitor profile information, and the like. In addition, the data can include third party or external data pertaining to ad impressions, revenue, realized revenue, ad costs, or a variety of customized data that can be specified by clients.

Any suitable type of web analytics system can be utilized. But one example of a commercially available web analytics system is the Adobe® SiteCatalyst®.

Having considered an example web analytics data acquisition process, consider now other aspects of an example user interface/dashboard in accordance with one or more embodiments.

### Example User Interface/Dashboard

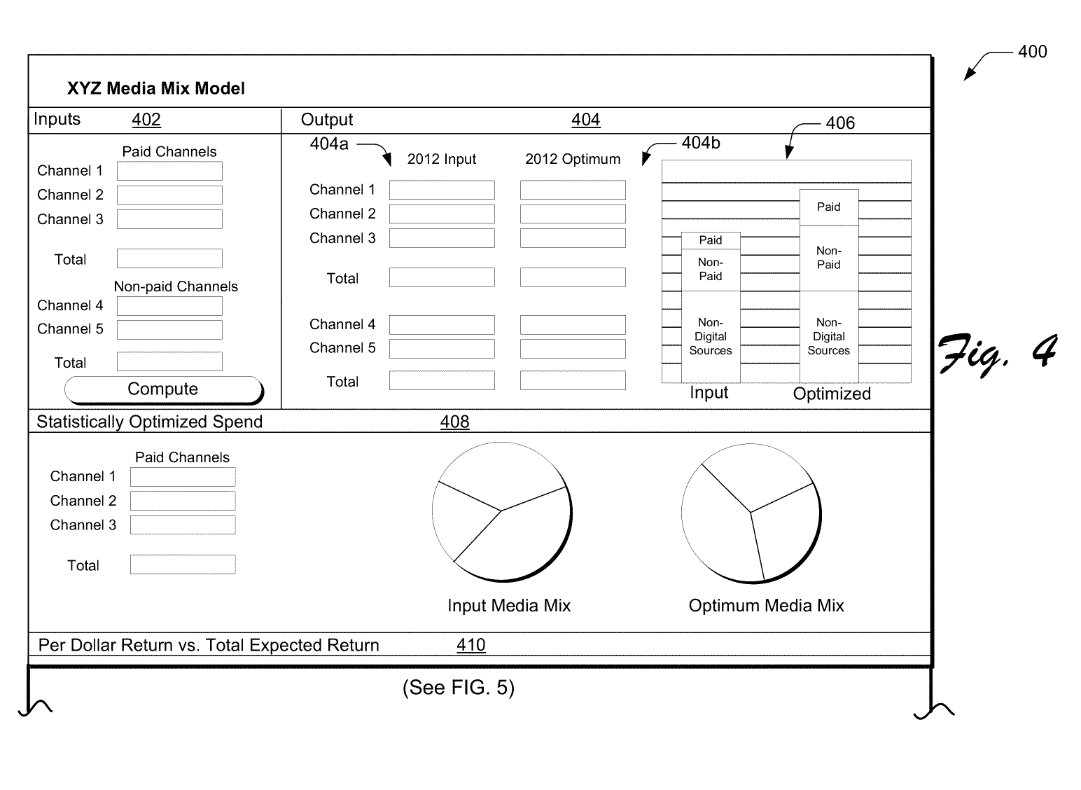

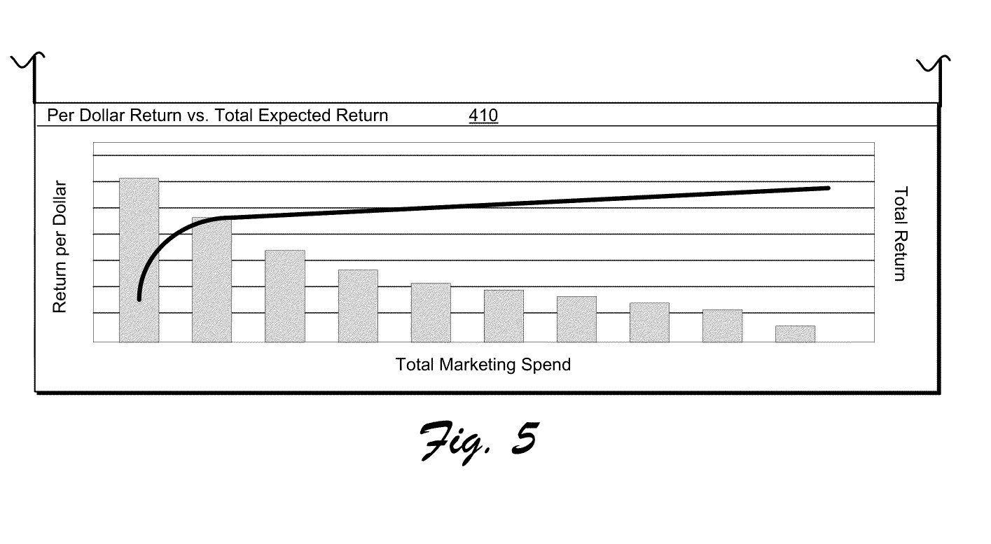

FIGS. 4 and 5 illustrate an example user interface/dashboard, generally at 400, that can be provided by user interface/dashboard module 204. The user interface/dashboard illustrated in FIGS. 4 and 5 is typically rendered as a single, integrated user interface. Here, it is split across two different figures simply because of spacing constraints.

The user interface/dashboard 400, as noted above, includes software code that analyzes a company's campaigns and revenues using an attribution model. Historical market spending is factored in to create a media mix model that provides marketers with information on how to allocate their marketing budget.

In the illustrated and described embodiment, user interface/dashboard 400 includes a data input portion 402, an expected return portion 404, a graphical breakdown portion 406, an optimized spend portion 408, and a graphical portion 410 (FIG. 5) illustrating the return based on the total budget spend.

In the illustrated and described embodiment, the data input portion 402 is configured to enable the user to input any particular budgetary constraints or amounts they wish to have analyzed. In this manner, historical data can be collected from individual companies and analyzed as described above and below. Data input portion 402 also enables the user to run theoretical budgets, e.g., “what if?” budgets, to ascertain the return for the theoretical budgets. In this particular example, fields are provided for both paid channels and non-paid channels. Thus a user can provide historical data for each particular channel that they use. Once the data has been input, the user simply clicks on the “Compute” button to have the analysis conducted.

The expected return portion 404 is configured to provide, for each particular channel, the expected return for a particular amount of money spent in a particular channel. In this particular example, a column 404a shows the expected return for the input that was provided through data input portion 402. Column 404b shows the expected return for an optimally-positioned marketing budget allocation.

The graphical breakdown portion 406 illustrates the breakdown of data appearing in columns 404a and 404b to provide a quick and intuitive visualization for the user.

The optimized spend portion 408 illustrates, on the left, the statistically optimized spend in terms of actual computed monetary amounts. To the right, the optimized spend portion 408 provides a graphical illustration of the input media mix entered by the user versus optimum media mix as computed by the user interface/dashboard module. Any suitable type of graphical illustration can be utilized such as, by way of example and not limitation, a pie chart.

Graphical portion 410 (FIG. 5) illustrates the per dollar return versus the total expected return. Here, the marketing spend in dollars extends along the x-axis. The leftmost y-axis represents return per dollar, and the rightmost y-axis represents the total return. The bars illustrate the return for every dollar spent. The curve illustrates a combination of all the curves generated for the different channels. Thus, the illustrated curve represents a collective view across all of the channels. In this example, the curve shows that there is a diminishing return as more and more money is allocated to the marketing budget.

### Using Different Curve-Fitting Methodologies

In one or more embodiments, different curve-fitting methodologies or models can be employed in connection with the scatter plot data for each campaign within a channel. For example, one curve-fitting model that can be utilized employs a log curve, as in the example of FIG. 2a. Another curve-fitting model that can be utilized employs the ADBUDG model. As will be appreciated by the skilled artisan, the ADBUDG model is an advertising sales response model that uses judgmental inputs on market response to determine the best level and timing of advertising expenditures. The ADBUDG model employs an S-shaped curve to attempt to fit the data in the scatterplot. In one or more embodiments, the ADBUDG model can be utilized with a statistically optimized parameter set. For example, the parameters can comprise a, b, c, and d, where:

“a” represents an initial share of a brand in the marketing channel;

“b” represents the amount of return expected if one were to spend $0 in a campaign channel (i.e., the y-intercept);

“c” defines the shape of the curve; in various embodiments, “c” is constrained to have a value between 1 and 2, with “1” being perfectly linear and “2” represents a parabolic shape; and

“d” represents a measure of market saturation, e.g., if one could spend an infinite amount of money, “d” represents the maximum return.

A solver can be employed to calibrate the parameters to yield a best fit. If using a natural log, a simple curve fitting regression can be performed and the resulting best fit equation parameters can be used. Alternately or additionally, the ADBUDG model can be utilized with parameters defined by the user. In one or more embodiments, parameters could also be “business rules”, e.g., including modeling constraints because of a known diminishing return on email or including a minimum amount of budget allocation for a particular channel due to business reasons.

In one or more embodiments, the user interface/dashboard 400 can be configured to enable the user to select which curve-fitting methodology or model they would like to use in connection with the data. So, for example, if a particular user feels that the statistically optimized model is too kind or too harsh, they can define their own model and use their own parameters to model their data. In addition, the user interface/dashboard can be configured to enable the user to choose the channels on which a particular model is to be applied.

Alternately or additionally, in one or more embodiments, a flexibility parameter is provided to enable flexibility in the analysis of marketing data. Essentially, the flexibility parameter enables the user to express a flexibility value that places constraints on how much is to be spent on a particular channel or how much a particular channel's spend allocation is to change.

### Example Method

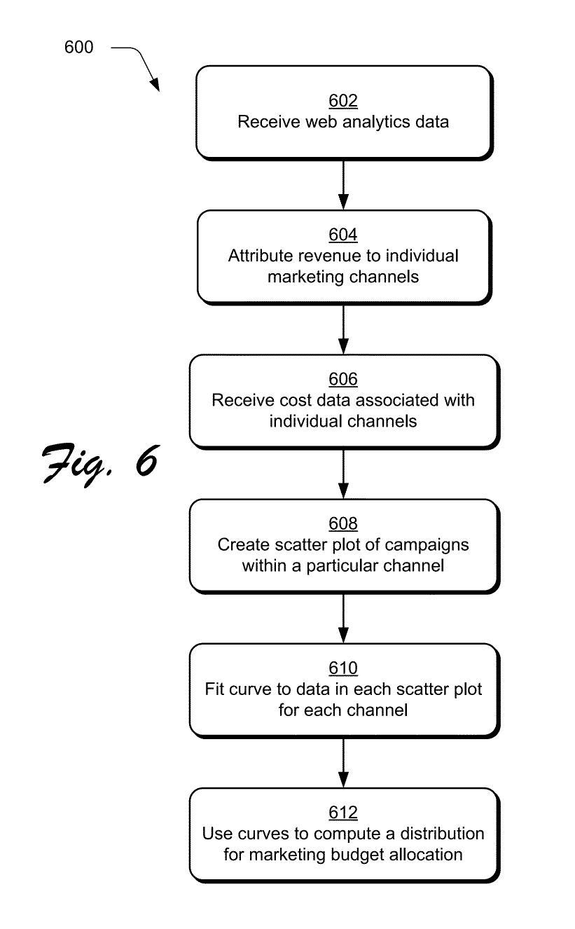

FIG. 6 depicts a procedure 600 in an example media mix modeling implementation in accordance with one or more embodiments. Aspects of the procedure may be implemented in hardware, firmware, or software, or a combination thereof. The procedure is shown as a set of blocks that specify operations performed by one or more devices and are not necessarily limited to the orders shown for performing the operations by the respective blocks.

At block 602, web analytics data is received. In one or more embodiments, the web analytics data is associated with an entity, such as a company that maintains a website, that utilizes online or Internet-based marketing channels. This operation can be performed in any suitable way. For example, in at least some embodiments, web analytics data is received from a suitable repository. Examples of web analytics data are provided above. At block 604, revenue is attributed to individual marketing channels that are utilized by the entity. Any suitable approach can be utilized to attribute revenue to the individual marketing channels. In at least some embodiments, statistical attribution is utilized.

At block 606, cost data associated with individual channels is received. This operation can be performed in any suitable way. For example, in at least some embodiments, a suitably-configured user interface can be utilized to enable entry of the cost data. Alternately or additionally, the cost data may be received automatically from a cost data repository. At block 608, scatter plots of various campaigns within each particular channel are created. The scatter plots provide a graphical description of how much money was spent on a particular campaign and the return for the particular campaign.

At block 610, a curve is fit to data in each scatterplot for each channel. This provides collection of curves for each of the channels utilized by the entity. At block 612, the curves are utilized to compute a distribution for marketing budget allocation. The marketing budget allocation that is computed can provide an allocation across each channel and across each campaign within each channel.

Having described an example method in accordance with one or more embodiments, consider now an example system and device that can be utilized to implement the described embodiments.

### Example System and Device

FIG. 7 illustrates an example system generally at 700 that includes an example computing device 702 that is representative of one or more computing systems and/or devices that may implement the various techniques described herein. This is illustrated through inclusion of the media mix modeling module 108, which operates as described above. The computing device 702 may be, for example, a server of a service provider, a device associated with a client (e.g., a client device), an on-chip system, and/or any other suitable computing device or computing system.

The example computing device 702 is illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712 and the media mix modeling module 108. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications (such as the media mix modeling module 108) and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### Conclusion

Various embodiments provide a media mix modeling tool that is configured to enable a marketing budget to be analyzed for purposes of allocation across different marketing channels and campaigns. In one or more embodiments, the media mix modeling tool utilizes and builds upon Web analytics data. For example, for particular channels that are to be the subject of a marketing investment, web analytics data is gathered for each channel. A statistical attribution method is then utilized to analyze the web analytics data to determine how much revenue should be attributed to each channel based on various touch points for each campaign. Cost data is then utilized to create a plot of campaigns within a particular channel. From this plot, a model is fitted that describes the performance of the particular channel. Once a model has been fit to each individual channel, a solver is applied to find a desirable or optimal way to distribute the marketing budget.

In one or more embodiments, a user interface is provided in the form of a dashboard to enable running of the models mentioned above and display of resultant data in an intuitive and user-friendly manner that provides flexibility in so far as enabling users to enter several budgets. The dashboard can enable users to ascertain their theoretical return for each of the budgets that are entered and to determine where their marketing dollars should be allocated.

Although the various embodiments have been described in language specific to structural features and/or methodological acts, it is to be understood that the embodiments defined in the appended claims are not necessarily limited to the specific features or acts described. Rather, the specific features and acts are disclosed as example forms of implementing the described embodiments.

What is claimed is:

1. A method implemented by a computing device, the method comprising:
receiving web analytics data associated with an entity that utilizes online or Internet-based marketing channels;
attributing revenue to the individual marketing channels;
receiving cost data associated with the individual marketing channels;
creating scatter plots of one or more campaigns within each marketing channel;
fitting a curve to data in each scatterplot for each channel; and
using fitted curves to compute a distribution for marketing budget allocation.

2. A method as described in claim 1, wherein said attributing is performed by statistically attributing revenue to the individual marketing channels.

3. A method as described in claim 1, wherein said attributing is performed by using a Bayesian estimator to attribute revenue.

4. A method as described in claim 1, wherein said receiving cost data is performed by receiving the cost data via a user interface.

5. A method as described in claim 1, wherein said receiving cost data is performed by receiving the cost data via a user interface that includes an expected return portion that is configured to provide, for each marketing channel, an expected return for a particular amount of money spent in a respective channel.

6. A method as described in claim 5, wherein the expected return portion is configured to show the expected return for input received via the user interface and the expected return for an optimally-positioned marketing budget allocation.

7. A method as described in claim 5, wherein the expected return portion is configured to show the expected return for input received via the user interface and the expected return for an optimally-positioned marketing budget allocation, and wherein the user interface further includes a graphical breakdown portion configured to illustrate a graphical breakdown of the expected return for input received via the user interface and the expected return for the optimally-positioned marketing budget allocation.

8. A method as described in claim 1, wherein said receiving cost data is performed by receiving the cost data via a user interface that includes an optimized spend portion configured to illustrate a statistically optimized spend per marketing channel.

9. A method as described in claim 1, wherein said receiving cost data is performed by receiving the cost data via a user interface that includes a graphical portion that illustrates per dollar return versus total expected return.

10. A method as described in claim 1, wherein said receiving cost data is performed by receiving the cost data via a user interface that includes a graphical portion that illustrates per dollar return versus total expected return and which includes a curve that is a combination of the curves generated for all of the marketing channels.

11. A method as described in claim 1, wherein said fitting a curve comprises utilizing a curve that has a decaying return.

12. A method as described in claim 1, wherein receiving web analytics data comprises receiving web analytics data that includes information across a variety of channels and different campaigns within individual channels.

13. One or more computer-readable storage media comprising instructions that are stored thereon that, responsive to execution by a computing device, causes the computing device to perform operations comprising:
receiving web analytics data associated with an entity that utilizes online or Internet-based marketing channels; and
using cost data associated with the marketing channels and the web analytics data to compute a statistically optimized marketing budget across the marketing channels.

14. One or more computer-readable storage media as described in claim 13, wherein the marketing channels include one or more of: search engine optimization, pay per click campaigns, social media marketing, affiliate marketing, shopping channel management, mobile marketing, video marketing, e-mail marketing, display advertising, or online PR and article marketing.

15. One or more computer-readable storage media as described in claim 13, wherein said using comprises statistically attributing revenue to each marketing channel.

16. One or more computer-readable storage media as described in claim 13, wherein said using comprises modeling each marketing channel with a curve that provides an indication of expected return for money spent within an associated channel.

17. One or more computer-readable storage media as described in claim 13, wherein said using comprises modeling each marketing channel with a curve that provides an indication of expected return for money spent within an associated channel and computing, from the curves, the statistically optimized marketing budget.

18. One or more computer-readable storage media as described in claim 13, wherein said using comprises modeling each marketing channel with a curve that provides an indication of expected return for money spent within an associated channel, wherein the curve comprises a log curve.

19. One or more computer-readable storage media as described in claim 13, wherein said using comprises modeling each marketing channel with a curve that provides an indication of expected return for money spent within an associated channel, wherein the curve comprises an S-shaped curve.

20. One or more computer-readable storage media as described in claim 13, wherein said using comprises modeling each marketing channel with a curve that provides an indication of expected return for money spent within an associated channel, wherein the curve includes parameters that can be defined by a user.

21. One or more computer-readable storage media as described in claim 13, wherein said using comprises modeling each marketing channel with a curve that provides an indication of expected return for money spent within an associated channel, wherein said curve is selectable from a plurality of curves.

22. One or more computer-readable storage media as described in claim 13, wherein said using comprises modeling each marketing channel with a curve that provides an indication of expected return for money spent within an associated channel, wherein said curve comprises a flexibility parameter to enable expression of a flexibility value that places constraints on how much is to be spent on a particular channel or how much a particular channel's spend allocation is to change.

23. A computing device comprising:
one or more processors;
one or more computer readable storage media embodying computer-readable instructions which, when executed under the influence of the one or more processors, implement a user interface comprising:
a data input portion configured to enable a user to input marketing budget amounts associated with individual online or Internet-based marketing channels effective to enable the marketing budget amounts to be analyzed with web analytics data to compute a statistically optimized marketing budget across the marketing channels; and
an expected return portion that is configured to provide, for each marketing channel, an expected return for a particular amount of money spent in a respective channel.

24. The computing device of claim 23, wherein the expected return portion is configured to show the expected return for input received via the data input portion and the expected return for an optimally-positioned marketing budget allocation.

25. The computing device of claim 23, wherein the expected return portion is configured to show the expected return for input received via the data input portion and the expected return for an optimally-positioned marketing budget allocation, and
wherein the user interface further includes a graphical breakdown portion configured to illustrate a graphical breakdown of the expected return for input received via the data input portion and the expected return for the optimally-positioned marketing budget allocation.

26. The computing device of claim 23, wherein the user interface includes an optimized spend portion configured to illustrate a statistically optimized spend per marketing channel.

27. The computing device of claim 23, wherein the user interface includes a graphical portion that illustrates per dollar return versus total expected return.

28. The computing device of claim 23, wherein the user interface includes a graphical portion that illustrates per dollar return versus total expected return and which includes a curve that is a combination of curves generated for all of the marketing channels.

29. One or more computer-readable storage media comprising instructions that are stored thereon that, responsive to execution by a computing device, causes the computing device to implement a system comprising:
a data gathering module configured to receive web analytics data associated with an entity that utilizes online or Internet-based marketing channels;
a statistical attribution module configured to attribute revenue to the individual marketing channels;
a user interface/dashboard module configured to receive cost data associated with the individual marketing channels, create scatter plots of one or more campaigns within each marketing channel, and fit a curve to data in each scatter plot for each channel; and
a solver module configured to use the fitted curves to compute a distribution for marketing budget allocation.

30. The one or more computer-readable storage media of claim 29, wherein said statistical attribution module comprises a Bayesian estimator.

31. The one or more computer-readable storage media of claim 29, wherein said user interface/dashboard module comprises an expected return portion that is configured to provide, for each marketing channel, an expected return for a particular amount of money spent in a respective channel.

32. The one or more computer-readable storage media of claim 29, wherein said user interface/dashboard module comprises an expected return portion that is configured to provide, for each marketing channel, an expected return for a particular amount of money spent in a respective channel, wherein the expected return portion is configured to show the expected return for received cost data and the expected return for an optimally-positioned marketing budget allocation.

33. The one or more computer-readable storage media of claim 29, wherein said user interface/dashboard module comprises an expected return portion that is configured to provide, for each marketing channel, an expected return for a particular amount of money spent in a respective channel, wherein the expected return portion is configured to show the expected return for received cost data and the expected return for an optimally-positioned marketing budget allocation, and wherein the user interface/dashboard module further includes a graphical breakdown portion configured to illustrate a graphical breakdown of the expected return for received cost data and the expected return for the optimally-positioned marketing budget allocation.

34. The one or more computer-readable storage media of claim 29, wherein said user interface/dashboard module comprises an optimized spend portion configured to illustrate a statistically optimized spend per marketing channel.

35. The one or more computer-readable storage media of claim 29, wherein said user interface/dashboard module comprises a graphical portion that illustrates per dollar return versus total expected return.

36. The one or more computer-readable storage media of claim 29, wherein said user interface/dashboard module comprises a graphical portion that illustrates per dollar return versus total expected return, and a curve that is a combination of curves generated for all of the marketing channels.
